(19) United States
(12) Patent Application Publication
(10) Pub. No.: US 2025/0175238 A1
(43) Pub. Date: May 29, 2025

(54) METHOD, DEVICE AND COMPUTER READABLE MEDIUM FOR COMMUNICATIONS

(71) Applicant: NEC CORPORATION, Tokyo (JP)

(72) Inventors: Gang WANG, Beijing (CN); Yukai GAO, Beijing (CN)

(73) Assignee: NEC CORPORATION, Tokyo (JP)

(21) Appl. No.: 18/725,422

(22) PCT Filed: Dec. 29, 2021
(86) PCT No.: PCT/CN2021/142689

§ 371 Date: Jun. 28, 2024

(51) Int. Cl. H04B 7/06; H04L 5/00; H04W 74/0833; H04W 80/02

(52) U.S. Cl. CPC H04B 7/06964; H04L 5/0051; H04W 74/0833; H04W 80/02

(57) ABSTRACT

Embodiments of the present disclosure relate to methods, devices, and computer readable medium for communication. According to some embodiments, in accordance with a determination that beam failure is detected for all of a plurality of beam failure detection-reference signal (BFD-RS) sets on a cell, initiating, with a network device in the cell, a random access (RA) procedure on the cell; and in accordance with a determination that the RA procedure is successfully completed, cancelling a plurality of beam failure recovery (BFR) procedures triggered for the plurality of BFD-RS sets on the cell.

### TECHNICAL FIELD

Embodiments of the present disclosure generally relate to the field of telecommunication, and in particular, to methods, devices, and computer readable medium for communication.

### BACKGROUND

A carrier aggregation (CA) technology to increase the system bandwidth may be supported in the NR system. When CA is used, there may be a number of cells configured for a terminal device. Generally, a primary cell (PCell) and at least one secondary cell (SCell) are provided. A beam failure may occur on one or more of the cells for the terminal device when the quality of beam pair(s) of the one or more cells falls low enough, for example, by comparison with a threshold or time-out of an associated timer.

A beam failure recovery (BFR) procedure is a mechanism for recovering beams when all or part of beams serving a terminal device has failed. If the terminal device detects a beam failure on a cell, a BFR procedure is needed to recover from the beam failure.

### SUMMARY

In general, example embodiments of the present disclosure provide a solution for communication.

In a first aspect, there is provided a communication method. The method comprises: in accordance with a determination that beam failure is detected for all of a plurality of beam failure detection-reference signal (BFD-RS) sets on a cell, initiating, with a network device in the cell, a random access (RA) procedure on the cell; and in accordance with a determination that the RA procedure is successfully completed, cancelling a plurality of beam failure recovery (BFR) procedures triggered for the plurality of BFD-RS sets on the cell.

In a second aspect, there is provided a terminal device. The terminal device comprises a processing unit, where the processing unit is configured to perform the method according to the first aspect.

In a third aspect, there is provided a computer readable medium having instructions stored thereon, the instructions, when executed on at least one processor, causing the at least one processor to perform the method according to the first aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication system in which embodiments of the present disclosure can be implemented;

FIG. 2 is a schematic diagram of an example for beam failure detection;

FIG. 3 is a schematic diagram of example signaling scenarios performed for BFR;

FIG. 4 illustrates a flowchart of a process for BFR in accordance with some embodiments of the present disclosure;

FIGS. 5A and 5B illustrate schematic diagrams of current formats for a Media Access Control Control Element (MAC CE);

FIG. 6 illustrates a schematic diagram of an example format for a MAC CE in accordance with some embodiments of the present disclosure;

FIG. 7A illustrates a schematic diagram of an example format for a MAC CE in accordance with some embodiments of the present disclosure;

FIG. 7B illustrates a schematic diagram of an example format for a MAC CE in accordance with some further embodiments of the present disclosure;

FIG. 7C illustrates a schematic diagram of an example format for a MAC CE in accordance with some yet further embodiments of the present disclosure;

FIG. 7D illustrates a schematic diagram of an example format for a MAC CE in accordance with some yet further embodiments of the present disclosure;

FIG. 8A illustrates a schematic diagram of an example format for a MAC CE in accordance with some embodiments of the present disclosure;

FIG. 8B illustrates a schematic diagram of an example format for a MAC CE in accordance with some further embodiments of the present disclosure;

FIG. 8C illustrates a schematic diagram of an example format for a MAC CE in accordance with some yet further embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communication (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communication and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band above 71 GHz, frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communication discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communication (GSM) and the like. Furthermore, the communication may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

### Example Environment

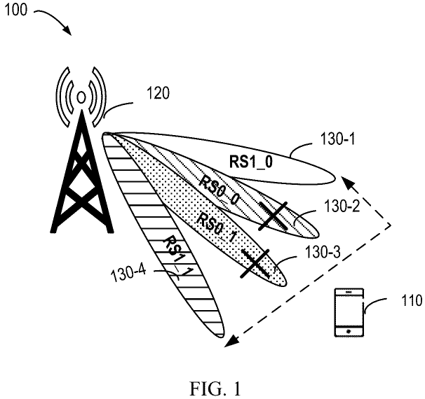

FIG. 1 illustrates a schematic diagram of a communication system in which embodiments of the present disclosure can be implemented. The communication system 100, which is a part of a communication network, comprises a network device 120 and a terminal device 110 served by the network device 120.

In operation, the network device 120 can communicate data and control information to the terminal device 110 and the terminal device 110 can also communication data and control information to the network device 120. A link from the network device 120 to a terminal device 110 is referred to as a downlink (DL), while a link from a terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

It is to be understood that the number of network devices and terminal devices is only for the purpose of illustration without suggesting any limitations. The communication environment 100 may include any suitable number of network devices and terminal devices adapted for implementing embodiments of the present disclosure.

Communication in the communication system 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G) and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The slot used herein may refer to a normal slot which comprises a predetermined number of symbols and also refer to a sub-slot which comprises fewer symbols than the predetermined number of symbols.

In some embodiments, the network device 120 may configure one or more cells to serve the terminal device 110. The cells may comprise a primary cell (PCell), one or more secondary cells (Scells), and so on. In some embodiments, a primary secondary cell (PSCell) among all the Scells may be configured for the terminal device 110. The PCell or the PSCell may sometimes be referred to as a special cell (SpCell).

There may be different beams configured for a cell. In some embodiments, the network device 120 may be configured to implement beamforming technique and transmit signals to the terminal device 110 via a plurality of beams. The terminal device 110 is configured to receive the signals transmitted by the network device 120 via the plurality of beams.

The terminal device 110 performs a beam discovery procedure to search for a beam(s) of high quality, for example, to switch from a beam to another beam when quality of the previous beam worsens. The network device 120 may transmit a reference signal (RS) with a beam. Such a RS may be referred to as a Beam Failure Detection (BFD)-RS. The terminal device 110 may be configured with a BFD-RS set to search for a beam with the satisfied quality.

Currently, for a certain cell, it is proposed that the network device 120 may operate as a multi-transmission/reception point (mTRP) and thus comprises a plurality of TRPs. For example, the network device 120 may be equipped with multiple antenna panels, each operating as a TRP. In this case, a BFD-RS set may be configured for each of the plurality of TRPs of the cell. A BFD-RS set may comprise a plurality of candidate BFD-RS. The terminal device 110 may search for the beams with a plurality of BFD-RS sets corresponding to the plurality of TRPs. As used herein, a BFD-RS set of a cell is equivalent to a TRP of the cell, and the two terms may be used interchangeably.

In some embodiments, the terminal device 110 may receive configuration (e.g., a RadioLinkMonitoringConfig information element) about BDF-RS sets of a cell from the network device 120. The terminal device 110 may determine a plurality of BFD-RS sets configured for the cell based on the configuration. For example, the terminal device 110 may determine a first BFD-RS set from failureDetectionResourcesToAddModList in the RadioLinkMonitoringConfig information element, and determine a second BFD-RS set from bfdResourcesToAddModList in the RadioLinkMonitoringConfig information element.

As illustrated in FIG. 1, as an example, it is assumed that the network device 120 operates as two TRPs (represented as TRP1 and TRP2) and thus configures two BFD-RS sets for the two TRPs, respectively. The terminal device 110 may detect a BFD-RS represented as RS0_0 with a beam 130-2 and a BFD-RS represented as RS0_1 with a beam 130-3 for TRP1, and a BFD-RS represented as RS1_0 with a beam 130-1 and a BFD-RS represented as RS1_1 with a beam 130-4 for TRP2. In some cases, the terminal device 110 may fail to successfully detect the beam (or the BFD-RS). For example, the terminal device 110 may fail to detect the beams 130-2 and 130-3 in the illustrated example of FIG. 1. Beam failure is detected by counting beam failure instances based on a certain BFD-RS.

In the case that beam failure is detected, a BFR procedure may be triggered to indicate to the network device 120 of a new candidate beam (or a new candidate BFD-RS). In some cases, a random access procedure may be initiated for beam failure recovery, for example, if a new configuration for beam failure recovery is reconfigured by upper layers for a SpCell. A triggered BFR procedure is also referred to as a triggered BFR, or a BFR triggered, or a BFR procedure triggered.

In current communication system, there are existing specifications for a network device operating as a single TRP for a cell, which specifies that the terminal device may perform BFR based on parameters specific for the cell, e.g., a maximum count for a beam failure instance (BFI) counter, and an expiration time for a timer. With the introduction of mTRP, it is proposed to set TRP-specific (or BFD-RS set-specific) parameters, e.g., TRP-specific maximum counts for BFI counters and TRP-specific expiration times for timers.

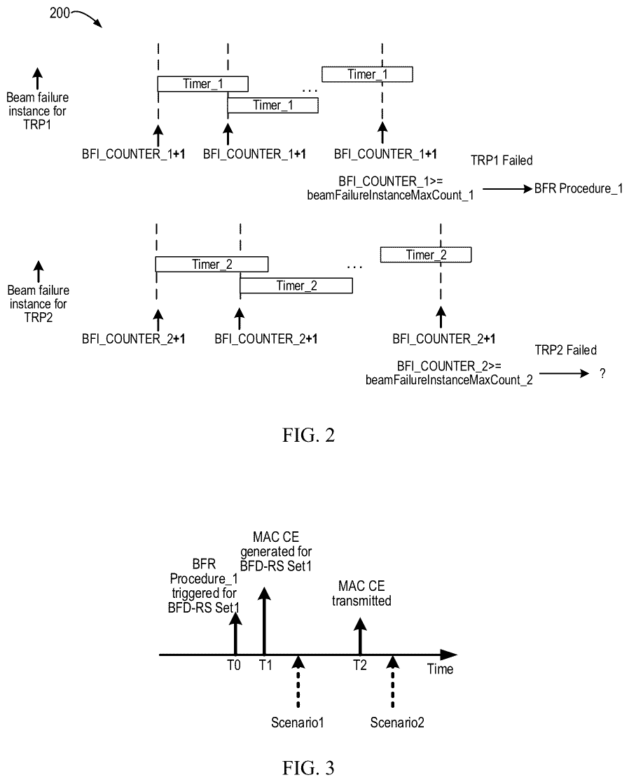

FIG. 2 is a diagram of an example 200 for beam failure detection. In this example, it is assumed that a network device operates as two TRPs (e.g., TRP1 and TRP2) for a certain cell and thus configures two BFD-RS sets for the two TRPs. A specific BFI counter (BFI_COUNTER1) and a specific timer (Timer_1) is configured for TRP1 (with BFD-RS Set1), and a specific BFI counter (BFI_COUNTER2) and a specific timer (Timer_2) is configured for TRP2 (with a BFD-RS Set2).

For TRP1, if a terminal device detects beam failure based on a BFD-RS from the BFD-RS Set1, it may determine that this is a beam failure instance and thus may increment BFI_COUNTER1 and start Timer1. Before expiration of Timer 1, if the terminal device detects another beam failure instance, it may further increment BFI_COUNTER1 and restart Timer1. This process repeats until BFI_COUNTER1 is larger than or equal to a maximum count for beam failure instances specific to TRP1 (represented as beamFailureInstanceMaxCount_1). In this case, it is determined that beam failure is detected for BFD-RS Set1, i.e., TRP2 is failed, and thus a BFR procedure (BFR Procedure1) is triggered for BFD-RS Set1.

For TRP2, if a terminal device detects beam failure based on a BFD-RS from the BFD-RS Set2, it may determine that this is a beam failure instance and thus may increment BFI_COUNTER2 and start Timer2. Before expiration of Timer 2, if the terminal device detects another beam failure instance, it may further increment BFI_COUNTER2 and restart Timer2. This process repeats until BFI_COUNTER2 is larger than or equal to a maximum count for beam failure instances specific to TRP2 (represented as beamFailureInstanceMaxCount_2). In this case, it is determined that beam failure is detected for BFD-RS Set2, i.e., TRP2 is failed. At this time, beam failure is detected for both BFD-RS Set1 and BFD-RS Set2 of the cell, which means that beam failure is detected for the whole cell. It thus is needed to further discuss how to handle BFR at this time, for example, to trigger a BFR procedure for BFD-RS Set2 or to only trigger a RA procedure for the cell.

Further, during a BFR procedure and a RA procedure, BFR information related to one or more BFD-RS set for which beam failure is detected may be transmitted from a terminal device to a network device, so as to request for beam failure recovery. However, in the case of mTRP, it is needed to specify how BFR information is transmitted.

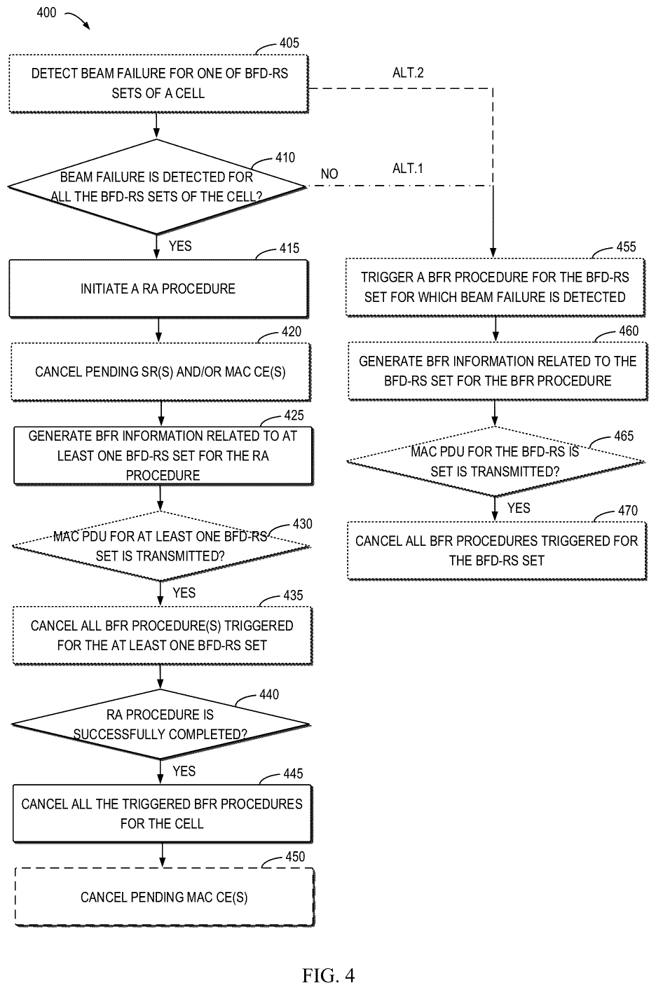

FIG. 3 is a schematic diagram of example signaling scenarios performed for BFR in the example of FIG. 2. If BFR Procedure 1 is triggered for BFD-RS Set1 at a time T0, the terminal device may generate a MAC CE containing BFR information related to BFD-RS Set1 at a time T1. The terminal device may wait for an uplink grant for transmitting the MAC CE. When the uplink grant is available at a time T2, the terminal device may transmit the MAC CE. When beam failure is detected for both BFD-RS Set2 and BFD-RS Set1, there are some possible scenarios occurred no matter whether a RA procedure or a BFR procedure is triggered. Scenario1 occurs between T1 and T2 when BFR Procedure_1 has triggered and MAC CE containing the BFR information related to BFD-RS Set1 is not transmitted. Scenario2 occurs after T2 when BFR Procedure_1 has triggered and the MAC CE generated for BFR Procedure_1 is transmitted. In these example scenarios, it is desired to generate appropriate BFR information to be transmitted to the network device, without increasing signaling overhead by transmitting redundant information and saving resources.

According to embodiments of the present disclosure, there are provided some solutions for multi-TRP (mTRP) beam failure recovery on a cell. In some embodiments, a solution is proposed to specify a process for beam failure recovery at a terminal device. In some further embodiments, a solution is proposed to specify example formats for BFR information related to one or more BFD-RS sets for which beam failure is detected.

Embodiments of the present disclosure will be described in detail below.

### Example Process for Beam Failure Recovery

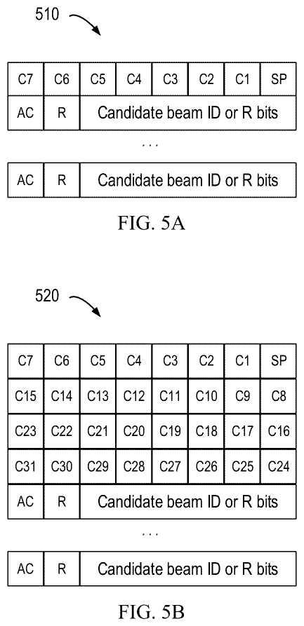

Reference is first made to FIG. 4, which shows a flowchart of a process 400 for beam failure recovery according to some embodiments of the present disclosure. The process 400 may be implemented at a terminal device. For the convenience of discussion, the process 400 is described with reference to FIG. 1 and thus can be implemented by the terminal device 110. In the embodiments related to the process 400, the network device 120 operates as an mTRP in a cell. The terminal device 110 performs beam discovery based on a plurality of BFD-RS sets configured for a plurality of TRPs of the cell.

At block 410, the terminal device 110 determines whether beam failure is detected for all of the plurality of BFD-RS sets on the cell. In some embodiments, the determination of whether beam failure is detected for all of the plurality of BFD-RS sets may be triggered if beam failure is detected for one of the plurality of BFD-RS sets. For example, before block 410, the terminal device 110 detects, at block 405, beam failure for one of the plurality of BFD-RS sets of the cell. In the case that the beam failure is detected for a certain BFD-RS set, the terminal device 110 may further determine whether beam failure is detected for all the BFD-RS sets of the cell.

In some embodiments, for a certain BFD-RS set, the terminal device 110 may detect whether beam failure occurs for this BFD-RS set based on a set of parameters specific to this BFD-RS set, e.g., BFD-RS set-specific (or TRP-specific) parameters, e.g., a BFD-RS set-specific maximum count for a BFI counter and a BFD-RS set-specific expiration time for a timer. In an example, if the terminal device 110 fails to detect a BFD-RS with a beam and the timer for a BFD-RS set does not expire, it may increment a BFI counter for the BFD-RS set by one. In the BFI counter is larger than or equal to the BFD-RS set-specific maximum count, the terminal device 110 may determine that beam failure is detected for this BFD-RS set.

If the terminal device 110 determines that beam failure is detected for all of the plurality of BFD-RS sets of the cell, which may mean that all TRPs of the cell fails, then at block 415, the terminal device 110 initiates a RA procedure on the cell. For one example, assuming that two BFD-RS sets are configured for a cell, beam failure is detected for all of the plurality of BFD-RS sets of the cell means that BFR is triggered for one of the two BFD RS-sets of the cell while the BFR for another BFD RS-set of the same cell is still not cancelled. As another example, assuming that two BFD-RS sets are configured for a cell, beam failure is detected for all of the plurality of BFD-RS sets of the cell means that BFR is triggered for one of the two BFD RS-sets of the cell while the BFR for another BFD RS-sets of the same cell is still not successfully completed or not recovered. The RA procedure is initiated for beam failure recovery on the cell. The RA procedure may be any type of contention-based RA (CBRA) procedure or contention-free RA (CFRA) procedure, or any type of four-step RA procedure or two-step RA procedure. In some other embodiments, all triggered BFR procedures for each BFD-RS set of a cell may be cancelled if the RA procedure is initiated for beam failure recovery of the cell.

In some embodiments, if beam failure is detected for all of the plurality of BFD-RS sets of the cell, the terminal device 110 may further determine whether the cell is a SpCell. In the case that the cell is the SpCell, the terminal device 110 may initiate the RA procedure on the SpCell.

The terminal device 110 performs the RA procedure with the network device 120. At block 425, the terminal device 110 generates BFR information related to at least one of the plurality of BFD-RS sets for the RA procedure. During the RA procedure, the terminal device 110 may transmit, to the network device 120, the generated BFR information related to one or more of the plurality of BFD-RS sets. In some embodiments, the terminal device 110 may generate a MAC CE to contain the BFR information. Such a MAC CE may also be referred to as a BFR MAC CE or enhanced BRF MAC CE in some embodiments of the present disclosure. The MAC CE may be included in a packet, e.g., in a MAC protocol data unit (PDU) to be transmitted to the network device 120. In an example, a MAC entity of the terminal device 110 may instruct the Multiplexing and Assembly entity to generate the BFR MAC CE and include it into the MAC PDU.

Some example embodiments related to the BFR information and example formats for the MAC CE containing the BFR information will be discussed in further detail below.

In the process 400, at block 440, the terminal device 110 determines whether the RA procedure is successfully completed. If the RA procedure is successfully completed, at block 445, the terminal device 110 cancels a plurality of BFR procedures triggered for the plurality of BFD-RS sets on the cell.

In some cases, if beam failure is detected for a certain BFD-RS set, a BFR procedure may be triggered for the BFD-RS set. To perform the BFR procedure, the terminal device 110 may request for an uplink grant or use an available uplink grant to transmit BFR information related to this BFD-RS set. The terminal device 110 may generate a MAC CE containing the BFR information related to this BFD-RS set and transmit the MAC CE in a MAC PDU using the uplink grant when this grant is available. In some embodiments, more than one BFR procedure may be triggered for a BFD-RS set. For example, with the BFI counter for a BFD-RS set incremented, it may still exceed the maximum count, and thus another BFR procedure may be triggered for the BFD-RS set.

As analyzed with reference to FIG. 3, at the time that beam failure is detected for a last BFD-RS set, BFR procedures may have been triggered for one or more BFD-RS sets and in some cases, will be triggered for the last BFD-RS set. The BFR procedures may last for a certain time because the terminal device 110 may need to generate BFR information related to respective BFD-RS sets, and wait for available uplink grants for transmission of the BFR information. If the RA procedure is successfully completed, which means that the BFR information related to one or more of the plurality of BFD-RS sets may have been successfully received by the network device 120, the terminal device 110 cancels all the triggered (and pending) BFR procedures so that no more MAC CE may be generated or transmitted in the triggered BFR procedures. In this way, the signaling overhead between the terminal device and the network device may be decreased, and the consumption of the terminal device may also be decreased.

In some embodiments, if the RA procedure is initiated, at block 420, the terminal device 110 may cancel one or more scheduling requests (SRs) for transmission of BFR information related to one or more BFD-RS sets, and/or one or more pending MAC CEs generated to indicate BFR information related to one or more BFD-RS sets, and/or one or more other pending MAC CEs, and/or one or more other pending SRs.

A scheduling request may be generated for a BFR procedure that is triggered for a certain BFD-RS set, so as to request for an uplink grant for transmission of BFR information related to this BFD-RS set. The scheduling request may be pending for being transmitted to the network device 120. Since the BFR information related to the BFD-RS set may be transmitted during the initiated RA procedure, the terminal device 110 may cancel the pending scheduling request. As a result, the signaling overhead is decreased and the network device 120 may not need to allocate uplink resources for the BFR information.

In some embodiments, the terminal device 110 may cancel all pending scheduling request(s), especially in the case that the cell is a SpCell. Since beam failure is detected for all the BFD-RS sets of the cell, this cell may not be suitable for serving the terminal device 110 with the current beams and thus may not be able to respond to any scheduling requests. Thus, cancelling all the pending scheduling request(s) may avoid usefulness signaling to the cell.

As mentioned above, a MAC CE may be generated to include BFR information related to a certain BFD-RS set if a BFR procedure is triggered for this BFD-RS set. Since the RA procedure is initiated and the BFR information related to this BFD-RS set may be transmitted during the initiated RA procedure, the terminal device 110 may cancel the MAC CE if it is generated but not transmitted.

In some embodiments, after the terminal device 110 cancels all the triggered BFR procedures for the plurality of BFD-RS sets, it may cancel, at block 450, one or more pending MAC CEs generated to indicate BFR information related to one or more BFD-RS sets. Those MAC CE(s) are generated for the corresponding triggered BFR procedure(s) but have no chance to be transmitted before the corresponding BFR procedure(s) are cancelled. In some embodiments, the terminal device 110 may cancel the pending MAC CE(s) at block 420 either in response to the RA procedure is initiated or in response to the corresponding BFR procedure(s) are cancelled.

In some embodiments, during the RA procedure, the terminal device 110 may determine, at block 430, whether a MAC PDU for one or more BFD-RS sets is transmitted during this BFR procedure. The MAC PDU for the BFD-RS set(s) includes a MAC CE containing BFR information related to the BFD-RS set. If the MAC PDU for the BFD-RS set(s) is transmitted, which means that the BFR information related to the corresponding BFD-RS set(s) is transmitted, the terminal device 110 may cancel, at block 435, all BFR procedure(s) triggered for the BFD-RS set(s). In some embodiments, the triggered and pending BFR procedure(s) may be cancelled.

According to the embodiments of the present disclosure, for any BFD-RS set, through the cancelling operations at block 445 and at block 430, all the triggered BFR procedure(s) for this BFD-RS set can be cancelled either during the RA procedure or during the BFR procedure.

Since a RA procedure is initiated when beam failure is detected for all of the plurality of BFD-RS sets of the cell, in some embodiments, the terminal device 110 may not trigger a BFR procedure for a last BFD-RS set for which beam failure is detected. In this case, an example trigger condition for a BFR procedure may be based on beam failure being detected for a certain BFD-RS set but not for all of the plurality of BFD-RS sets of the cell, as in Alt.1 in the process 400. If beam failure is detected for a certain BFD-RS set but not for all of the plurality of BFD-RS sets of the cell (Alt.1), the terminal device 110 may trigger, at block 455, a BFR procedure for the BFD-RS set for which beam failure is detected at block 405.

As an example, it is assumed that two BFD-RS sets are configured for a cell. If the terminal device 110 detects beam failure for a first BFD-RS set, it may determine whether beam failure is detected for both the two BFD-RS sets. If not, the terminal device 110 may trigger a BFR procedure for a first BFD-RS set in response to beam failure detected for the first BFD-RS set. Then the terminal device 110 further detects beam failure for a second BFD-RS set. At this time, beam failure is detected for both the two BFD-RS sets. Thus, the terminal device 110 does not trigger a BFR procedure for the second BFD-RS set, but initiate a RA procedure on the cell.

It is noted that in some embodiments, the terminal device 110 may not trigger a BFR procedure for a last BFD-RS set for which beam failure is detected, no matter whether the terminal device 110 is configured to cancel all the triggered BFR procedures after the RA procedure is successfully completed.

In some embodiments, if beam failure is detected for a certain BFD-RS set of a cell and this BFD-RS set is a last BFD-RS set of the cell for which beam failure is detected, the terminal device 110 may trigger a BFR procedure. In other words, the terminal device 110 may trigger a BFR procedure for each of the BFD-RS sets of the cell, including the last BFD-RS set, for which beam failure is detected. In this case, an example trigger condition for a BFR procedure may be based on beam failure being detected for a certain BFD-RS set, as in Alt.2 in the process 400. The terminal device 110 may determine whether beam failure is detected for any BFD-RS set of a cell and if beam failure is detected for a BFD-RS set (Alt.2), the terminal device 110 may trigger, at block 455, a BFR procedure for the BFD-RS set for which beam failure is detected at block 405. According to some embodiments described for the process 400, this triggered BFR procedure may be cancelled if the RA procedure initiated for beam failure recovery of the cell is successfully completed, or if BFR information related to the BFD-RS set is transmitted (e.g., in a MAC PDU). In other words, all triggered BFR procedures for each BFD-RS set of a cell may be cancelled if the RA procedure initiated for beam failure recovery of the cell is successfully completed.

In some embodiments, if beam failure is detected for two or more of the plurality of BFD-RS sets of a cell simultaneously and then beam failure has been detected for all the BFD-RS sets, the terminal device 110 may trigger a plurality of BFR procedures each for one of the some or all of the plurality of BFD-RS sets. One or more of the BFR procedures may probably be cancelled according to the embodiments of the process 400. In some embodiments, if beam failure is detected for two or more of the plurality of BFD-RS sets of a cell simultaneously and then beam failure has been detected for all the BFD-RS sets, the terminal device 110 may not trigger a BFR procedure for any of the two or more BFD-RS sets for which beam failure is detected simultaneously. A RA procedure is initiated in response to the trigger condition that beam failure is detected for all the BFD-RS sets.

In some embodiments, in response to the triggered BFR procedure, at block 460, the terminal device 110 may generate BFR information related to the BFD-RS set for the BFR procedure. The BFR information may be contained in a MAC CE. In some embodiments, the terminal device 110 may determine, at block 465, whether a MAC PDU for this BFD-RS set is transmitted during the BFR procedure. The MAC PDU for the BFD-RS set includes a MAC CE containing BFR information related to this BFD-RS set. If the MAC PDU for this BFD-RS set is transmitted, which means that the BFR information related to this BFD-RS set is transmitted, the terminal device 110 may cancel, at block 470, all BFR procedure(s) triggered for this BFD-RS set. In some embodiments, the triggered and pending BFR procedure(s) may be cancelled.

In the above embodiments, it is mentioned that BFR information related to one or more BFD-RS sets may be generated during the RA procedure and BFR information related to a specific BFD-RS set may be generated during a BFR procedure triggered for this specific BFD-RS set. In some embodiments, in the case of mTRP, in some embodiments, for a certain BFD-RS set, corresponding BFR information may indicate at least one of the following information pieces: an identity (ID) of the BFD-RS set for which the BFR procedure is triggered or beam failure is detected, an indication of whether a candidate beam is available or not for the BFD-RS set, and at least one candidate beam ID for the BFD-RS set if at least one candidate beam is available for the at least one BFD-RS set. As a beam is associated with a BFR-RS, a candidate beam ID may also be indicated by a candidate RS ID. An identity or ID of a BFD-RS set may also be referred to as an identifier or an index of the BFD-RS set. Similarly, a candidate beam identity or ID may also be referred to as a candidate beam identifier or a candidate beam index.

As compared with traditional communication systems where a single BFD-RS set is configured for a cell, in the case of mTRP, the BFR information related to the respective BFD-RS sets may be referred to as enhanced BFR information. The MAC CE containing the enhanced BFR information may be referred to as an enhanced or new MAC CE or an enhanced or new BFR MAC CE.

In some embodiments, since the RA procedure is initiated when beam failure is detected for all the plurality of BFD-RS sets, the terminal device 110 may generate and transmit BFR information related to any of the plurality of BFD-RS sets. In some embodiments, the terminal device 110 may generate and transmit BFR information related to all of the plurality of BFD-RS sets. In some embodiments, the terminal device 110 may determine how to form the BFR information to be transmitted in the RA procedure based on a determination of whether BFR information related to any of the plurality of BFD-RS sets is transmitted during one or more BFR procedures triggered for one or more BFD-RS sets. For example, if BFR information related to a BFD-RS set is transmitted during a BFR procedure triggered for this BFD-RS set, the terminal device 110 may not include the BFR information related to this BFD-RS set into a MAC CE to be transmitted during the RA procedure. As another example, if BFR information related to a BFD-RS set is included in the MAC CE containing the enhanced BFR information in accordance with a BFR procedure triggered for this BFD-RS set but not sent yet, the terminal device 110 may not include the BFR information related to this BFD-RS set into a MAC CE to be transmitted during the RA procedure.

In some embodiments, the RA procedure may determine for which one or more BFD-RS sets the BFR information is included in the MAC CE. The RA procedure may indicate, to the Multiplexing and Assembly entity, to include the BFR information related to the one or more BFD-RS sets in a packet (e.g., a MAC PDU or MAC CE) to be transmitted. In some embodiments, a BFR procedure triggered for a BFD-RS set may indicate to the RA procedure whether BFR information related to this BFD-RS set is transmitted. By collecting indication from one or more BFR procedure, the RA procedure may determine for which one or more BFD-RS sets the BFR information is included in the MAC CE and indicate, to the Multiplexing and Assembly entity, to include the BFR information related to the one or more BFD-RS sets. In some embodiments, the Multiplexing and Assembly entity itself may determine for which one or more BFD-RS sets the BFR information is included in the MAC CE, and generate the MAC CE accordingly. For example, the determining of for which one or more BFD-RS sets the BFR information is included in the MAC CE means that do not include those BFR information related to one or more BFD-RS sets which are transmitted. As another example, the determining of for which one or more BFD-RS sets the BFR information is included in the MAC CE means that include the BFR information related to one or more BFD-RS sets even if they are transmitted. In some embodiments, the terminal device 110 may be configured by the network device 120 whether to send those already transmitted BFR information related to the one or more BFD-RS sets during the RA procedure.

In some embodiments, the terminal device 110 may initiate a four-step RA procedure for beam failure recovery and may transmit the BFR information in a message 3 (MSG3) of the four-step RA procedure. In some embodiments, the terminal device 110 may initiate a two-step RA procedure for beam failure recovery and may transmit the BFR information in a message A (MSGA) of the two-step RA procedure.

In some embodiments where the BFR information is transmitted in MSG3, the terminal device 110 may not cancel the triggered BFR procedures (also referred to as a PC5-RRC entity)) after the BFR information is transmitted, but may cancel the triggered BFR procedures after the RA procedure is successfully completed. In some embodiments, the network device 120 may not select a candidate beam (or BFD-RS) ID from the RA preamble index, but based on the received MAC CE in MSG3 or MSGA. In some embodiments, the network device 120 may rely on a mapping from Synchronization Signal block (SSB) indexes to RA preamble indexes to determine a candidate beam (or BFD-RS) ID. In some embodiments, the network device 120 may configure the terminal device 110 how the candidate beam ID is indicated. The configuration may be based on a condition of whether the BFR information is related to more than one BFD-RS set and/or a condition of whether there is no corresponding preamble index or RA resource mapped for a candidate RS ID to be reported by the terminal device 110.

### Example Formats of Enhanced BFR MAC CE

In some embodiments described above, a MAC CE is generated to include BFR information related to one or more BFD-RS sets of a cell. In some embodiments, a solution is proposed to specify example formats for a MAC CE containing BFR information related to one or more BFD-RS sets for which beam failure is detected.

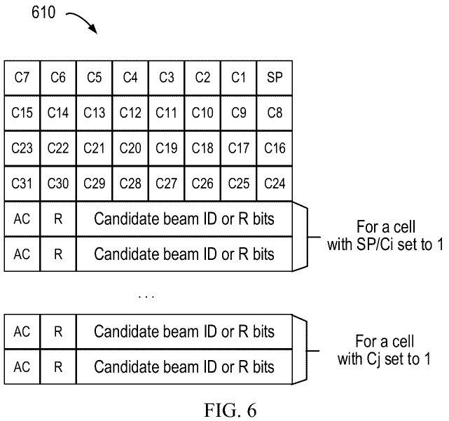

Current formats for a MAC CE containing BFR information are briefly introduced with reference to FIGS. 5A and 5B.

FIG. 5A is a schematic diagram illustrating a format 510 for a BFR MAC CE or truncated BFR MAC CE with a single octet bitmap (e.g. Cᵢ field). As shown, the format 510 comprises a one-octet cell index bitmap. Each SP/Cᵢ field (i=1, 2, . . . , 7) in the cell index bitmap may include one bit corresponding to a SpCell (represented as “SP”) or a cell with a cell index (also referred to as ServCellIndex) Cᵢ, used to indicate a result of beam failure detection on that cell. The SP/Cᵢ field set to 1 indicates that beam failure is detected, the evaluation of the candidate beams has been completed. The SP/Cᵢ field set to 0 indicates that the beam failure is either not detected or the beam failure is detected but the evaluation of the candidate beams has not been completed. Of source, the values of the bits may be set as vice versa to indicate the results of the beam failure detection. The format 510 is used for a BFR MAC CE when the highest cell index of a cell for which beam failure is detected and the evaluation of the candidate beams according to the requirements has been completed is less than 8. The format 510 is used for a Truncated BFR MAC CE when the highest cell index of a cell for which beam failure is detected and the evaluation of the candidate beams according to the requirements has been completed is less than 8; or, beam failure is detected for the SpCell and the SpCell is to be indicated in a Truncated BFR MAC CE and the Uplink Shared Channel (UL-SCH) resources available for transmission cannot accommodate the Truncated BFR MAC CE with the four octets bitmap plus its sub-header as a result of logical channel prioritization (LCP).

If a bit corresponding to a SpCell or a cell with a cell index Cᵢ in the cell index bitmap is set to 1, the format 510 may further comprise an octet containing a candidate beam availability field (referred to as an AC field). The AC field indicates the presence of the candidate beam ID field in this octet. If the AC field set to 1, the candidate beam ID field is present. If the AC field set to 0, R bits are present instead. The candidate beam ID field is set to a candidate beam ID if the AC field set to 1, or set to reserved bits (R bits) if the AC field set to 0. The length of the candidate beam ID field is 6 bits. The octet containing the AC field may further comprises an R bit adjacent to the AC field, which may set to 0.

The octets containing the AC fields are sorted in the MAC CE in ascending order based on the cell indexes with the SP/Cᵢ fields set to 1. In some cases, the number of the octets containing the AC fields may be zero.

FIG. 5B is a schematic diagram illustrating another example format 520 for a BFR MAC CE or truncated BFR MAC CE with bitmap of four octets (e.g. Cᵢ field). The different between the format 520 and the format 510 is that the format 520 comprises a four-octet cell index bitmap to indicate results of beam failure detection on at most 32 cells. The octets containing the AC fields in the format 520 may be set similarly as in the format 510.

According to some embodiments of the present disclosure, to indicate BFR information related to one or more BFD-RS sets in a MAC CE, some enhanced formats are provided. The BFR information may be generated by the terminal device 110 based on any of these enhanced formats.

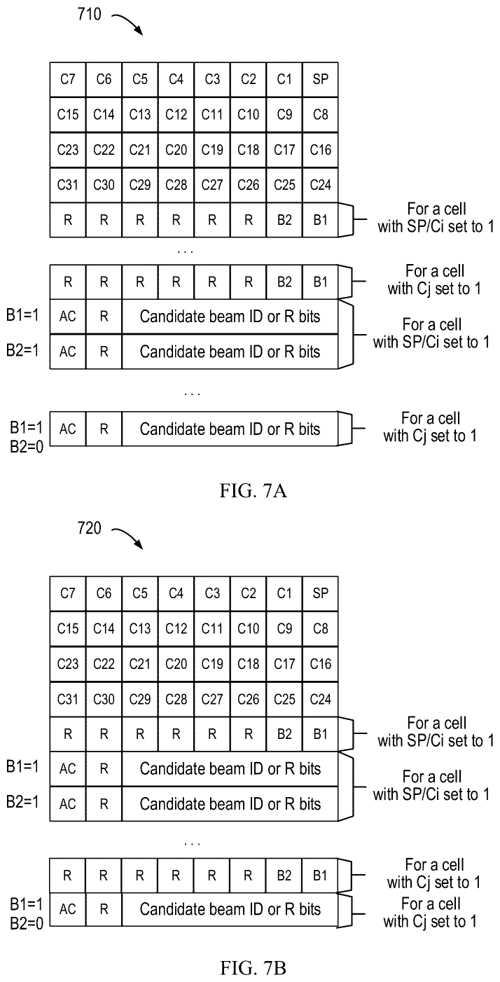

FIG. 6 illustrates a schematic diagram of an example format 610 for a MAC CE in accordance with some embodiments of the present disclosure. In the example of FIG. 6 and following examples, the format is illustrated as containing a four-octet cell index bitmap. However, it would be appreciated that the format of the MAC CE proposed in the present disclosure may comprise a one-octet cell index bitmap instead. It would also be appreciated that the total number of cells indexed by the cell index bitmap may be configured as any other number.

As illustrated, the example format 610 for the MAC CE comprises a cell index bitmap comprising SP/Cᵢ fields (i=1, 2, . . . , 31) to indicate a result of beam failure detection on that cell. The SP/Cᵢ field set to 1 indicates that beam failure is detected on a corresponding cell and the evaluation of the candidate beams has been completed. The SP/Cᵢ field set to 0 indicates that the beam failure is either not detected or the beam failure is detected but the evaluation of the candidate beams has not been completed. Of source, the values of the bits may be set as vice versa to indicate the results of the beam failure detection. In embodiments of the present disclosure, the case of mTRP, if a SP/Cᵢ field is set to 1 to indicate that beam failure is detected on a cell, it means that beam failure is detected for one BFD-RS set of the cell or for more than one or all of the BFD-RS sets of the cell. In some embodiments of the present disclosure, in the case of mTRP, if a SP/Cᵢ field is set to 1 to indicate that beam failure is detected on a cell, it means that beam failure is detected for one BFD-RS set of the cell or for more than one or all of the BFD-RS sets of the cell, and the evaluation of the candidate beams has been completed for these BFD-RS sets. In some embodiments of the present disclosure, in the case of mTRP, if a SP/Cᵢ field is set to 0 to indicate that beam failure is not detected on a cell, it means that beam failure is not detected for any BFD-RS sets of the cell or for more than one or all of the BFD-RS sets of the cell the beam failure are detected but the evaluation of the candidate beams has not been completed for these BFD-RS sets.

In the example of FIG. 6, for a cell with a corresponding SP/Cᵢ/Cⱼ field set to 1 (i or j=1, 2, . . . , 31, and i≠j), the example format 610 for the MAC CE further comprises a plurality of information segments containing the AC fields, with each of the plurality of information segments corresponding to one of a plurality of BFD-RS sets of the cell. It is noted that among the cells indexed by the cell index bitmap, one or more of the cells may not be configured with a plurality of BFD-RS sets. That is, one or more of the cells may be configured with only one BFD-RS set.

An information segment has a unit length. In the example of FIG. 6 and following examples, an information segment is illustrated as an octet although in other examples it may comprise more than one octet. In FIG. 6, the number of the information segments present for a certain cell is equal to the number of the BFD-RS sets configured for the cell. For example, it is assumed that a cell with a corresponding SP/Cᵢ/Cⱼ field set to 1 is configured with two BFD-RS sets and thus comprises two octets for each cell, where i or j=1, 2, . . . , 31, and i≠j.

In some embodiments, the information segments (e.g., octets) containing the AC fields for a certain cell may be sorted according to the BFD-RS set IDs (e.g., in an ascending order of the BFD-RS set IDs). For example, for a cell configured with two BFD-RS sets, the first octet containing the AC field is corresponding to a first BFD-RS set and the second octet containing the AC field is corresponding to a second BFD-RS set of this cell, where the ID of the first BFD-RS set may be in a lower order than the ID of the second BFD-RS set.

In some embodiments, the information segments (e.g., octets) containing the AC fields for a certain cell may be present only if the corresponding SP/Cᵢ/Cⱼ field is set to 1.

In some embodiments, the information segments (e.g., octets) containing the AC fields for each cell may be sorted according to the cell IDs (e.g., in an ascending order of the cell IDs). For example, the first set of information segments is corresponding to the special cell, the second set of information segments is corresponding to Cᵢ, and the third set of information segments is corresponding to Cⱼ (i<j).

For a cell with a corresponding SP/Cᵢ field set to 1, beam failure may be detected for one or more of the BFD-RS sets. An information segment containing the AC field corresponding to a certain BFD-RS set may contain a first field to indicate whether beam failure is detected for the corresponding BFD-RS set and a second field to indicate a candidate beam ID available for the corresponding BFD-RS set for which the beam failure is detected.

In some embodiments, the R bit contained in an information segment (e.g., octet) containing the AC field may be used as the first field, to indicate whether beam failure is detected for the corresponding BFD-RS set. For example, the R bit is set to 1 if beam failure is detected for the corresponding BFD-RS set, and the R bit is set to 0 if beam failure is not detected for the corresponding BFD-RS set. As another example, the R bit is set to 1 if beam failure is detected and the evaluation of the candidate beams has been completed for the corresponding BFD-RS set, and the R bit is set to 0 if beam failure is either not detected or the evaluation of the candidate beams has not been completed for the corresponding BFD-RS set.

According to the correspondence between the information segments containing the AC fields and the BFD-RS sets as well as the values of the first fields in the information segments, it is possible to indicate to the network device 120 an identity of a BFD-RS set for which beam failure is detected or for which beam failure is detected and the evaluation of the candidate beams has been completed.

The second field is set to indicate a candidate beam ID if a candidate beam is available for the corresponding BFD-RS set and thus also be referred to as a candidate beam ID field. The second field comprises R bits (e.g., set to 0) if a candidate beam is unavailable for the corresponding BFD-RS set. In some embodiments, the AC field may be set to 1 if the candidate beam ID field is present, and may be set to 0 if R bits are present instead in the second field.

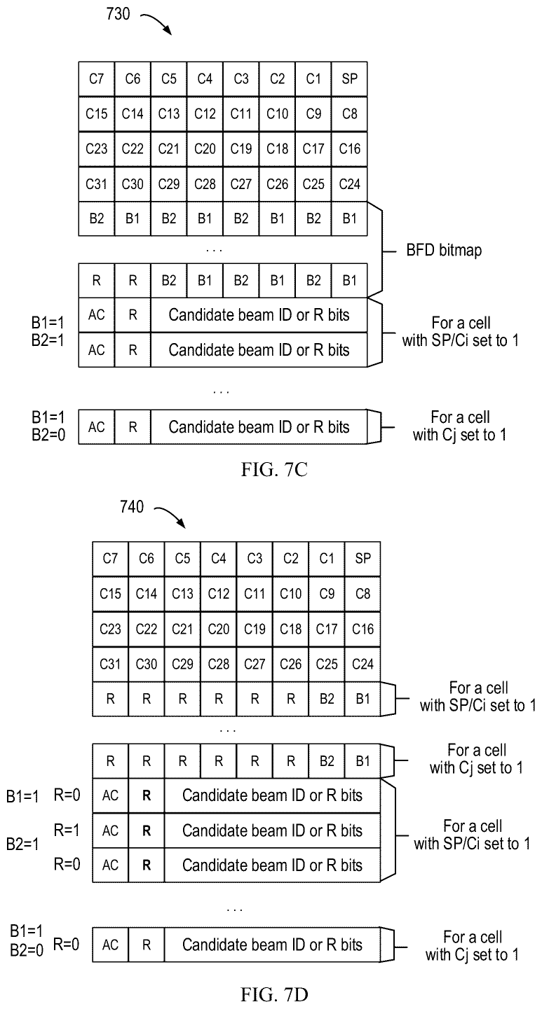

FIGS. 7A-7D illustrate some further example formats for a MAC CE in accordance with some embodiments of the present disclosure.

FIG. 7A illustrates an example format 710 for the MAC CE, which comprises a cell index bitmap comprising SP/Cᵢ fields (i=1, 2, . . . , 31) to indicate a result of beam failure detection on that cell. The SP/Cᵢ field set to 1 indicates that beam failure is detected on a corresponding cell and the evaluation of the candidate beams has been completed. The SP/Cᵢ field set to 0 indicates that the beam failure is either not detected or the beam failure is detected but the evaluation of the candidate beams has not been completed. Of source, the values of the bits may be set as vice versa to indicate the results of the beam failure detection. In embodiments of the present disclosure, the case of mTRP, if a SP/Cᵢ field is set to 1 to indicate that beam failure is detected on a cell, it means that beam failure is detected for one BFD-RS set of the cell or for more than one or all of the BFD-RS sets of the cell.

In the example of FIG. 7A, for a cell with a corresponding SP/Cᵢ/Cⱼ field set to 1 (i or j=1, 2, . . . , 31, and i≠j), the example format 710 for the MAC CE further comprises an information segment containing a plurality of beam failure detection (BFD) fields for this cell. Each of the plurality of BFD fields is corresponding to one of the plurality of BFD-RS sets to indicate whether beam failure is detected for the corresponding BFD-RS set. The information segment may be an octet, and a BFD field may comprise a bit in the octet. In some embodiments, a BFD field may be set to 1 if beam failure is detected for the corresponding BFD-RS set and the evaluation of the candidate beams has been completed. In some embodiments, a BFD field may be set to 0 if the beam failure is either not detected or the beam failure is detected but the evaluation of the candidate beams has not been completed.

A BFD field may be represented as Bi, where i=1, 2, . . . , N, and N is the total number of BFD-RS sets configured for a cell. For example, the BFD field may be present for a cell with a corresponding SP/Cᵢ field set to 1. The number of the BFD fields for a certain cell is equal to the number of the BFD-RS sets configured for the cell. In the illustrated example, it is assumed that a cell with a corresponding SP/Cᵢ/Cⱼ field set to 1 is configured with two BFD-RS sets and thus comprises an octet may contain two BFD fields. In some embodiments, if more than eight BFD-RS sets are configured for a cell, the information segment may comprise more than one octet. In some embodiments, the length of the information segment containing BFD fields may be the same for all the cells.

In some embodiments, the BFD fields may be arranged according to the BFD-RS set IDs (e.g., in an ascending order of the BFD-RS set IDs) in an information segment. For example, for a cell configured with two BFD-RS sets, the first BFD field (B1 field) is corresponding to a first BFD-RS set and the second BFD field (B2 field) is corresponding to a second BFD-RS set of this cell, where the ID of the first BFD-RS set may be in a lower order than the ID of the second BFD-RS set.

According to the correspondence between the BFD fields and the BFD-RS sets as well as the values of the BFD fields in the information segments, it is possible to indicate to the network device 120 an identity of a BFD-RS set for which beam failure is detected.

In some embodiments, the format 710 for the MAC CE may further comprise at least one information segment containing an AC field to indicate at least one candidate beam ID available for a BFD-RS set for which beam failure is detected. In the format 710, for a cell with a corresponding SP/Cᵢ/Cⱼ field set to 1, a BFD field corresponding to a BFD-RS set may indicate whether beam failure is detected for the corresponding BFD-RS set. Thus, if the BFD field is set to indicate that beam failure is detected for the corresponding BFD-RS set, e.g., set to 1, the format 710 may further comprise one or more information segments (e.g., octets) containing an AC field to indicate at least one candidate beam ID available for the corresponding BFD-RS set.

In some embodiments, the number of information segments to be comprised for a certain BFD-RS set may be varied based on the number of candidate beams detected as available for the corresponding BFD-RS set. In some embodiments, if no candidate beam is available for a BFD-RS set for which beam failure is detected, the format 710 may comprise one information segment (e.g., octet) containing an AC field for this BFD-RS set but the information segment comprises R bits instead of a candidate beam ID field.

In some embodiments, if beam failure is detected for a BFD-RS set but no candidate beam is available for this BFD-RS set, the format 710 may comprise no information segment (e.g., octet) containing an AC field for this BFD-RS set. Thus, for a given cell, as compared with the fixed number of information segments containing AC fields in FIG. 6, the number of information segments containing AC fields in a MAC CE may be varied in FIG. 7A.

In some embodiments, if a BFD field is set to indicate that beam failure is not detected for a BFD-RS set, e.g., set to 0, the format 710 may comprise no information segment (e.g., octet) containing an AC field for this BFD-RS set. Thus, for a given cell, as compared with the fixed number of information segments containing AC fields in FIG. 6, the number of information segments containing AC fields in a MAC CE may be varied in FIG. 7A.

In some embodiments, the information segments containing AC fields for a cell may be arranged in the MAC CE according to the BFD-RS set IDs (e.g., in an ascending order of the BFD-RS set IDs). For example, for a cell configured with two BFD-RS sets, one or more information segments containing AC fields for a first BFD-RS set may be placed before one or more information segments containing AC fields for a second BFD-RS set of this cell, where the ID of the first BFD-RS set may be in a lower order than the ID of the second BFD-RS set.

As an example, in FIG. 7A, for a cell with a corresponding SP/Cᵢ field set to 1, if the two BFD fields, B1 field and B2 field, are both set to 1 to indicate that beam failure is detected for both of the two BFD-RS sets of this cell, the format 710 for the MAC CE comprises two octets containing AC fields, each corresponding to one of the two BFD-RS sets. The first one of the two octets contains a candidate beam ID field to indicate a candidate beam ID for a first BFD-RS set that is corresponding to the B1 field, and the second one of the two octets contains a candidate beam ID field to indicate a candidate beam ID for a second BFD-RS set that is corresponding to the B2 field. In the example of FIG. 7A, for a cell with a corresponding Cⱼ field set to 1, if the B1 field is set to 1 and the B2 field is set to 0, the format 710 for the MAC CE comprises one octet containing an AC field for a first BFD-RS set corresponding to the B1 field. This octet contains a candidate beam ID field to indicate a candidate beam ID for the first BFD-RS set.

It is noted that the values of the BFD fields and the information segments containing AC fields illustrated in FIG. 7A are provided as a specific example, without suggesting any limitation.

In some embodiments, in a MAC CE, an information segment containing a plurality of BFD fields for a cell with a corresponding SP/Cᵢ field set to 1 is placed after the cell index bitmap and before at least one information segment containing an AC field. In some embodiments, if the cell index bitmap comprises two or more bits to indicate that beam failure is detected on two or more cells, then there may be two or more information segments containing BFD fields for the two or more cells. In the example of FIG. 7A, the information segments containing the BFD fields for all the cells with the SP/Cᵢ fields set to 1 may be placed immediately adjacent to each other. Those information segments containing the BFD fields are placed together after the cell index bitmap and before the information segments containing AC fields for those cells.

In another example format 720 for a MAC CE illustrated in FIG. 7B, an information segment containing BFD fields and at least one information segment containing an AC field for a cell with a corresponding SP/Cᵢ field set to 1 may be arranged adjacent to each other. For example, an information segment containing BFD fields for the cell with the corresponding SP/Cᵢ field set to 1 may be immediately before at least one information segment containing an AC field for the cell in the MAC CE. It is noted that the format 720 in FIG. 7B is generally similar to the format 710 in FIG. 7A except that their arrangements of the information segments containing BFD fields and information segments containing AC fields are different. In some embodiments, some remaining bits which are not corresponding to any BFD-RS set of a cell in an information segment containing BFD fields (e.g. B1 field and B2 field) may be set to R bits, e.g., set to 0, for the purpose of byte alignment. As illustrated in FIG. 7A and 7B, the last six bits in the information segment containing BFD fields for a cell may be set to R bits.

In some embodiments, different from the formats 710 and 720, a plurality of BFD fields for a cell may not be contained in an information segment with a unit length (e.g., an octet). Instead, a plurality of BFD fields for a cell may be placed adjacent to a plurality of BFD fields for another cell. FIG. 7C illustrates an example format 730 for a MAC CE according to those embodiments. The BFD fields for all the cells with the SP/Cᵢ fields set to 1 may form a BFD bitmap. In some examples, each bit in the BFD bitmap is corresponding to a BFD field for a BFD-RS set of a cell, to indicate whether beam failure is detected for the BFD-RS set of the cell.

In some embodiments, the length of the BFD bitmap may be in unit of octets. Some remaining bits which are not corresponding to any BFD-RS set of a cell may be set to R bits, e.g., set to 0, for the purpose of byte alignment. As illustrated in FIG. 7C, the last two bits in the BFD bitmap may be set to R bits.

In some embodiments, in the BFD bitmap, the BFD fields for all the cells with the SP/Cᵢ fields set to 1 may be arranged according to the cell indexes of those cells (e.g., in an ascending order of the cell indexes), and further according to the BFD-RS set IDs (e.g., in an ascending order of the BFD-RS set IDs).

The example formats 710, 720, and 730 of a MAC CE may be more flexible as the number of information segments (e.g., octets) containing AC fields for a cell may be variable according to the results of beam failure detection on the BFD-RS sets. As a result, it is possible to have a high forwarding capability of BFR information.

It would be appreciated that there may be some other variants for the format of a MAC CE with BFD fields to indicate whether beam failure is detected for respective BFD-RS sets. In some embodiments, instead of comprising an information segment containing BFD fields for a cell with the SP/Cᵢ fields set to 1 (e.g., in FIG. 7A and FIG. 7B) or comprising individual BFD fields for a cell with the SP/Cᵢ fields set to 1 in a BFD bitmap (e.g., in FIG. 7C), a further example format of a MAC CE may comprise a fixed number of information segments containing BFD fields or a fixed number of BFD fields in the BFD bitmap. This fixed number may be equal to the number of cells indexed in the cell index bitmap. For a given cell, if the SP/Cᵢ fields set to 0, the information segments containing BFD fields or the fixed number of BFD fields may be set to R bits, e.g., set to 0. In other words, for a given cell, if the SP/Cᵢ fields set to 0, the information segments containing BFD fields or the fixed number of BFD fields may not be encoded.

As the total number of BFD-RS sets configured for each cell may be variable, in the embodiments of the example formats illustrated in FIG. 6 and FIGS. 7A-7C, to generate the MAC CE according to any of those example formats, the terminal device 110 may first determine the total number of BFD-RS sets configured for a cell. In some embodiments, the terminal device 110 may receive configuration (e.g., a RadioLinkMonitoringConfig information element) about BDF-RS sets of a cell from the network device 120. The terminal device 110 may determine a plurality of BFD-RS sets configured for the cell based on the configuration. The terminal device 110 may determine the number of BFD-RS sets configured for a cell based on the received configuration. For example, the terminal device 110 determine a first BFD-RS set from may failureDetectionResourcesToAddModList in the RadioLinkMonitoringConfig information element, determine a second BFD-RS set from bfdResourcesToAddModList in the RadioLinkMonitoringConfig information element, and thus determine that the total number of BFD-RS sets is two.

In the example of FIG. 6, the total number of BFD-RS sets for a cell may be used to determine the number of information segments containing AC fields for this cell. In the examples of FIGS. 7A-7C, the total number of BFD-RS sets for a cell may be used to determine the size of information segment containing BFD fields for this cell (in FIGS. 7A and 7B) or the number of BFD fields in the BFD bitmap for this cell and thus the total size of the BFD bitmap (in FIG. 7C).

In some embodiments, the terminal device 110 may determine the total number of BFD-RS sets per cell and then the size of an information segment containing BFD fields for a cell (for the formats in FIGS. 7A and 7B) or the size of the BFD bitmap (for the format in in FIG. 7C). For example, if the total number of BFD-RS sets for a cell is less than 8, an information segment of a single octet may be enough to contain BFD fields corresponding to those BFD-RS sets. As another example, for the format 730 in FIG. 7C, the terminal device 110 may sum up the total numbers of BFD-RS sets of the cells with the SP/Cᵢ fields set to 1, to determine the size of the BFD bitmap. The size of the BFD bitmap may be determined in unit of octets, with remaining bits set as R bits. For example, if the total numbers of BFD-RS sets of a cell is N, the number of octets equals to ceil (mod (N,8)). In some embodiments, the terminal device 110 may receive, from the network device 120, a configuration indicating the size of an information segment containing BFD fields for each cell or the size of the BFD bitmap.

In some embodiments, as mentioned above, in the format 710 for the MAC CE as well as the format 720 and 730, there may be a variable number of information segments containing AC fields for a BFD-RS set. In some cases, the terminal device 110 may report more than one candidate beam for a BFD-RS set and thus more than one information segment containing the AC field may be contained in the MAC CE. To allow the network device 120 to correctly decode the candidate beam ID for a specific BFD-RS set of a cell, in some embodiments, according to a format of a MAC CE, an information segment containing an AC field may contain a first field to indicate presence of a next information segment containing an AC field for a specific BFD-RS set or indicate whether it is the last information segment containing an AC field for this specific BFD-RS set. The information segment containing an AC field may further contain a second field to indicate a candidate beam ID available for this specific BFD-RS set for which the beam failure is detected. Such an information segment containing an AC field may be contained in any of the formats 710, 720, and 730.

In some embodiments, a R bit contained in an information segment (e.g., octet) containing the AC field may be used as the first field, to indicate presence of a next information segment containing an AC field for a specific BFD-RS set or indicate whether it is the last information segment containing an AC field for this specific BFD-RS set. For example, the R bit in an information segment containing an AC field may be set to 1 to indicate that it is not the last information segment containing an AC field and there is at least one further information segment containing an AC field for this BFD-RS set. The R bit in an information segment containing an AC field may be set to 0 to indicate that it is the last information segment containing an AC field and there is no further information segment containing an AC field for this BFD-RS set.

For the purpose of illustration only, FIG. 7D shows an example format 740 for a MAC CE in accordance with some embodiments of the present disclosure. The format 740 is based on the format 710 in FIG. 7A. In the illustrated example, an R bit contained in an information segment (e.g., octet) containing the AC field is sued to indicate presence of a next information segment containing an AC field. For a cell with a corresponding SP/Cᵢ field set to 1, the two BFD fields, B1 field and B2 field, are both set to 1 to indicate that beam failure is detected for both of two BFD-RS sets of this cell. The format 740 for the MAC CE comprises two octets for the first BFD-RS set of this cell since the B1 field for this cell is set to 1. The R bit in the first octet is set to 0 to indicate that there is at least one further octet containing the AC field for the first BFD-RS set, and the R bit in the second octet is set to 0 to indicate that it is the last octet for the first BFD-RS set and there is no further octet containing the AC field for the first BFD-RS set. The format 740 for the MAC CE comprises a single octet for the second BFD-RS set of this cell because the B2 field is set to 1. The R bit in the single octet is set to 0 to indicate that it is the last octet for the second BFD-RS set and there is no further octet containing the AC field for the second BFD-RS set. It is noted that the values of the R bits may be set as vice versa to indicate presence of a next information segment containing an AC field (e.g., the R bit set to 1 to indicate absence of a next information segment containing an AC field while the R bit set to 0 to indicate presence of such a next information segment).

In the example of FIG. 7D, for a cell with a corresponding Cⱼ field set to 1, if the B1 field corresponding to the first BFD-RS set of this cell is set to 1 and the B2 field corresponding to the second BFD-RS set of this cell is set to 0, the format 740 may further comprise a single octet containing an AC field for the first BFD-RS set. The R bit in the single octet is set to 0 to indicate that it is the last octet for the first BFD-RS set and there is no further octet containing the AC field for the first BFD-RS set.

It is noted that the values of the BFD fields and R bits and the information segments containing AC fields illustrated in FIG. 7D are provided as a specific example, without suggesting any limitation. It would be appreciated that the R bits in the information segments (octets) containing AC fields in the formats 720 and 730 in FIGS. 7B and 7C are also be configured in a similar way as in FIG. 7D.

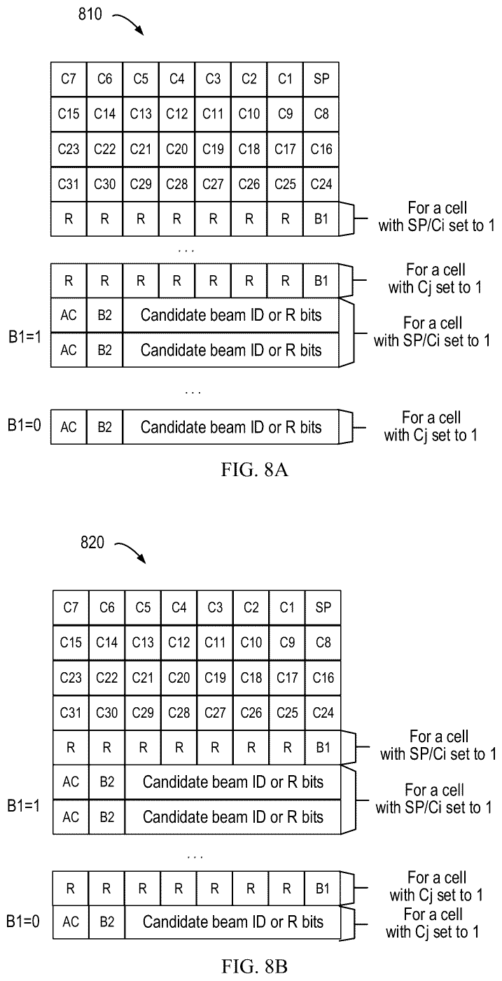

FIGS. 8A-7C illustrate some yet further example formats for a MAC CE in accordance with some embodiments of the present disclosure.

FIG. 8A illustrates an example format 810 for the MAC CE, which comprises a cell index bitmap comprising SP/Cᵢ fields (i=1, 2, . . . , 31) to indicate a result of beam failure detection on that cell. The SP/Cᵢ field set to 1 indicates that beam failure is detected on a corresponding cell and the evaluation of the candidate beams has been completed. The SP/Cᵢ field set to 0 indicates that the beam failure is either not detected or the beam failure is detected but the evaluation of the candidate beams has not been completed. Of source, the values of the bits may be set as vice versa to indicate the results of the beam failure detection. In embodiments of the present disclosure, the case of mTRP, if a SP/Cᵢ field is set to 1 to indicate that beam failure is detected on a cell, it means that beam failure is detected for one BFD-RS set of the cell or for more than one or all of the BFD-RS sets of the cell.

In the example of FIG. 8A, for a cell with a corresponding SP/Cᵢ/Cⱼ field set to 1 (i or j=1, 2, . . . , 31, and i≠j), the example format 710 for the MAC CE further comprises an information segment containing a BFD field (represented as B1 field in FIG. 8A) for this cell to indicate the number of BFD-RS sets for which beam failure is detected.

This BFD field may occupy a number of bits to indicate the total number of BFD-RS sets configured for a cell with a corresponding SP/Cᵢ field set to 1. In some embodiments, if a cell is configured with two BFD-RS sets, the BFD field may comprise one bit in the information segment. FIG. 7A illustrates that the BFD field (B1 field) occupies one bit. This BFD field may be set to 1 to indicate that beam failure is detected and the evaluation of the candidate beams according to the requirements have been completed for both of the BFD-RS sets. This BFD field may be set to 0 to indicate that beam failure is either not detected or the beam failure is not detected but the evaluation of the candidate beams according to the requirements have not been completed for both of the BFD-RS sets. In some embodiments, if the cell is configured with more than two BFD-RS sets, the BFD field may comprise more than one bit in the information segment. In some embodiments, the number of bits occupied by the BFD field may be determined by log2(N), where N is the total number of BFD-RS sets configured for a cell with a corresponding SP/Cᵢ field set to 1.

In some embodiments, if the number of BFD-RS sets is indicated by the BFD field as being larger than or equal to one, the format 810 for the MAC CE may further comprise a number of information segments containing AC fields, the number of the information segments containing the AC fields being equal to the number of BFD-RS sets indicated by the BFD field. Thus, each of the information segments containing AC fields may be corresponding to one of the BFD-RS sets for which beam failure is detected. In the illustrated example of FIG. 8A, for a cell with a corresponding SP/Cᵢ field set to 1, if the B1 field is set to 1, then two information segments (e.g., octets) containing AC fields are present for this cell. For a cell with a corresponding Cⱼ field set to 1, if the B1 field is set to 0, then a single information segment (e.g., octet) containing an AC field is present for this cell.

In some embodiments, each of the information segments containing AC fields may contains a first field (or a BFD field) to indicate an identity of a corresponding BFD-RS set and a second field to indicate a candidate beam identity for the corresponding BFD-RS set. The second field is set to indicate a candidate beam ID if a candidate beam is available for the corresponding BFD-RS set and thus also be referred to as a candidate beam ID field. The second field comprises R bits (e.g., set to 0) if a candidate beam is unavailable for the corresponding BFD-RS set.

In some embodiments, as illustrated in FIG. 8A, the legacy R bit contained in an information segment (e.g., octet) containing the AC field may be used as the first field (B2 field). In some other embodiments, the AC field contained in the information segment (e.g., octet) may be used as the first field (B2 field), and the legacy R bit contained in the information segment may be used as the AC field.

In some embodiments, for a certain BFD-RS set of a cell, there may be more than one information segment containing an AC field for this BFD-RS set, so as to indicate more than one candidate beam ID by the corresponding second fields. The first field in those information segments containing AC fields may be the same to indicate the identity of the corresponding BFD-RS set.

In some embodiments, the size of the first field may be based on the total number of BFD-RS sets configured for a cell with a corresponding SP/Cᵢ field set to 1. If the cell is configured with two BFD-RS sets, the first field may comprise one bit in the information segment. FIG. 8A illustrates that the first field (B2 field) occupies one bit (e.g., the legacy R bit). This first field may be set to 0 to indicate that an ID of a first BFD-RS set of the two BFD-RS sets, and may be set to 1 to indicate that an ID of a second one of the two BFD-RS sets. In the case that the cell is configured with more than two BFD-RS sets, the first field may comprise more than one bit in the information segment containing the AC field. The size of the first field may also be determined by log2(N), where N is the total number of BFD-RS sets configured for a cell with a corresponding SP/Cᵢ field set to 1. With the first field, the identity of the BFD-RS set for which beam failure is detected and the candidate beam ID for this BFD-RS set may be indicated to the network device 120 in the MAC CE.

In some embodiments, in a MAC CE, an information segment containing the BFD field (B1 field) for a cell with a corresponding SP/Cᵢ field set to 1 is placed after the cell index bitmap and before at least one information segment containing an AC field. In some embodiments, if the cell index bitmap comprises two or more bits to indicate that beam failure is detected on two or more cells, then there may be two or more information segments containing the BFD fields (B1 fields) for the two or more cells. In the example of FIG. 8A, the information segments containing the BFD fields (B1 field) for all the cells with the SP/Cᵢ fields set to 1 may be placed immediately adjacent to each other. Those information segments containing the BFD fields (B1 field) are placed together after the cell index bitmap and before the information segments containing AC fields for those cells.

In another example format 820 for a MAC CE illustrated in FIG. 8B, an information segment containing a BFD field (B1 field) and at least one information segment containing an AC field for a cell with a corresponding SP/Cᵢ field set to 1 may be arranged adjacent to each other. For example, an information segment containing the BFD field for the cell with the corresponding SP/Cᵢ field set to 1 may be immediately before at least one information segment containing an AC field for the cell in the MAC CE. It is noted that the format 820 in FIG. 8B is generally similar to the format 810 in FIG. 8A except that their arrangements of the information segments containing BFD fields and information segments containing AC fields are different. In some embodiments, some remaining bits which are not corresponding to any BFD-RS set of a cell in an information segment containing a BFD field (e.g. B1 field) may be set to R bits, e.g., set to 0, for the purpose of byte alignment. As illustrated in FIG. 8A and 8B, the last seven bits in the information segment containing a BFD field for a cell may be set to R bits.

In some embodiments, different from the formats 810 and 820, a BFD field (B1 field) for a cell may not be contained in an information segment with a unit length (e.g., an octet). Instead, the BFD field for a cell may be placed adjacent to a BFD field for another cell. FIG. 8C illustrates an example format 830 for a MAC CE according to those embodiments. The BFD fields (B1 field) for all the cells with the SP/Cᵢ fields set to 1 may form a BFD bitmap. In the illustrated example, each bit in the BFD bitmap is corresponding to a cell, to indicate the number of BFD-RS sets for which beam failure is detected on this cell. In other examples, a BFD field for a cell may occupy more than one bit in the BFD bitmap, depending on the total number of BFD-RS set configured for this set.

In some embodiments, the length of the BFD bitmap may be in unit of octets. Some remaining bits which are not corresponding to any BFD-RS set of a cell may be set to R bits, e.g., set to 0, for the purpose of byte alignment. As illustrated in FIG. 8C, the last two bits in the BFD bitmap may be set to R bits.

In some embodiments, in the BFD bitmap, the BFD fields for all the cells with the SP/Cᵢ fields set to 1 may be arranged according to the cell indexes of those cells, and further according to the BFD-RS set IDs (e.g., in an ascending order of the BFD-RS set IDs).

The example formats 810, 820, and 830 of a MAC CE may be more flexible as the number of information segments (e.g., octets) containing AC fields for a cell may be variable according to the results of beam failure detection on the BFD-RS sets. As a result, it is possible to have a high forwarding capability of BFR information.

It would be appreciated that there may be some other variants for the format of a MAC CE with a BFD field (B1 field) to indicate the number of BFD-RS sets of a cell for which beam failure is detected. In some embodiments, instead of comprising an information segment containing a BFD field for a cell with the SP/Cᵢ fields set to 1 (e.g., in FIG. 8A and FIG. 8B) or comprising individual BFD fields for a cell with the SP/Cᵢ fields set to 1 in a BFD bitmap (e.g., in FIG. 8C), a further example format of a MAC CE may comprise a fixed number of information segments containing BFD fields or a fixed number of BFD fields in the BFD bitmap. This fixed number may be equal to the number of cells indexed in the cell index bitmap. For a given cell, if the SP/Cᵢ fields set to 0, the information segments containing BFD fields or the fixed number of BFD fields may be set to R bits, e.g., set to 0.

As the total number of BFD-RS sets configured for each cell may be variable, in the embodiments of the example format illustrated in FIG. 8C, the terminal device 110 may determine the total number of BFD-RS sets per cell and then the size of size of the BFD bitmap. For example, the terminal device 110 may sump up the total numbers of BFD-RS sets of the cells with the SP/Cᵢ fields set to 1, to determine the size of the BFD bitmap. The size of the BFD bitmap may be determined in unit of octets, with remaining bits set as R bits. In some embodiments, the terminal device 110 may receive, from the network device 120, a configuration indicating the size of the BFD bitmap.

### Example Device

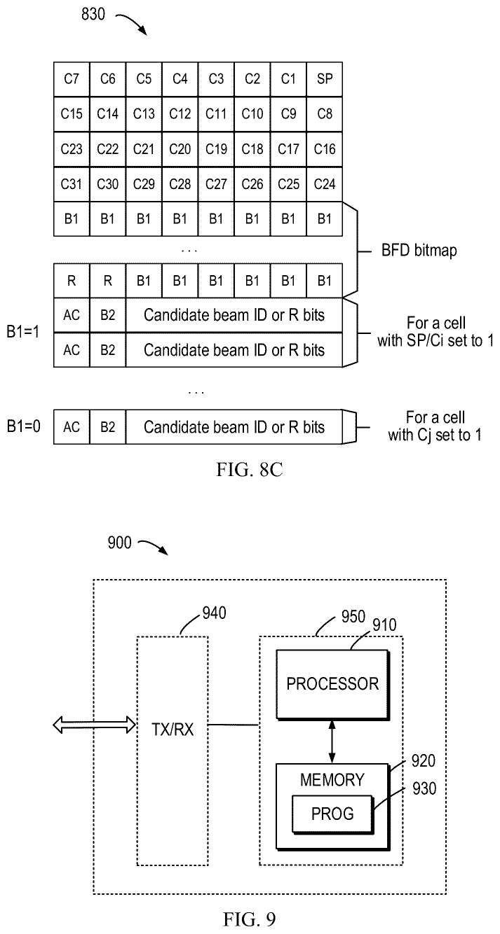

FIG. 9 is a simplified block diagram of a device 900 that is suitable for implementing embodiments of the present disclosure. The device 900 can be considered as an example implementation of the terminal device 110 or the network device 120 as shown in FIG. 1. Accordingly, the device 900 can be implemented at or as at least a part of the terminal device 110 or the network device 120.

As shown, the device 900 includes a processor (processing unit) 910, a memory 920 coupled to the processor 910, a suitable transmitter (TX) and receiver (RX) 940 coupled to the processor 910, and a communication interface coupled to the TX/RX 940. The memory 920 stores at least a part of a program 930. The TX/RX 940 is for bidirectional communication. The TX/RX 940 has at least one antenna to facilitate communication, though in practice an Access Node mentioned in this application may have several ones. The communication interface may represent any interface that is necessary for communication with other network elements, such as X2 interface for bidirectional communication between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 930 is assumed to include program instructions that, when executed by the associated processor 910, cause the device 900 to operate in accordance with the embodiments of the present disclosure, as discussed herein with reference to FIGS. 2 to 8C. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 8C. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (Iota) devices, Ultra-reliable and Low Latency Communication (URLLC) devices, Internet of Everything (Iowa) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communication and Iota applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (Node or NB), an evolved Node (anode or eNB), a next generation Node (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

What is claimed is:

1. A communication method comprising:
in accordance with a determination that beam failure is detected for all of a plurality of beam failure detection-reference signal (BFD-RS) sets on a cell, initiating, with a network device in the cell, a random access (RA) procedure on the cell; and
in accordance with a determination that the RA procedure is successfully completed, cancelling a plurality of beam failure recovery (BFR) procedures triggered for the plurality of BFD-RS sets on the cell.

2. The method of claim 1, further comprising:
after initiating the RA procedure, cancelling at least one of the following:
at least one scheduling request for transmission of BFR information related to at least one of the plurality of BFD-RS sets,
at least one scheduling request pending at the terminal device, or
at least one Medium Access Control Control Element (MAC CE) generated to indicate BFR information related to at least one of the plurality of BFD-RS sets.

3. The method of claim 1, further comprising:
in accordance with a determination that beam failure is detected for a first BFD-RS set of the plurality of BFD-RS sets of the cell and the first BFD-RS set is a last BFD-RS set of the plurality of BFD-RS sets for which beam failure is detected, triggering a BFR procedure for the first BFD-RS set.

4. The method of claim 1, further comprising:
in accordance with a determination that beam failure is detected for a second BFD-RS set of the plurality of BFD-RS sets of the cell,
determining whether beam failure is detected for all of the plurality of BFD-RS sets of the cell; and
in accordance with a determination that beam failure is not detected for all of the plurality of BFD-RS sets of the cell,
triggering a BFR procedure for the second BFD-RS set.

5. The method of claim 1, further comprising:
transmitting BFR information related to at least one of the plurality of BFD-RS sets during the RA procedure or during at least one of the plurality of BFR procedures triggered for the at least one BFD-RS set.

6. The method of claim 5, further comprising:
in accordance with a determination that the BFR information related to the at least one BFD-RS set is transmitted during the RA procedure or during the at least one BFR procedure,
cancelling the at least one BFR procedure triggered for the at least one BFD-RS set.

7. The method of claim 5, further comprising:
indicating, to a multiplexing and assembly entity of the terminal device by the RA procedure or at least one of the plurality of BFR procedures via the RA procedure, to include the BFR information related to the at least one BFD-RS set in a packet to be transmitted, or
determining, by the multiplexing and assembly entity, to include the BFR information related to the at least one BFD-RS set in a packet to be transmitted.

8. The method of claim 5, wherein transmitting the BFR information during the RA procedure comprises:
transmitting the BFR information in a message 3 (MSG3) of the RA procedure.

9. The method of claim 5, wherein the BFR information is comprised in a Medium Access Control Control Element (MAC CE), and indicates at least one of the following:
at least one identity of the at least one BFD-RS set for which beam failure is detected,
at least one indication of whether a candidate beam is available or not for the at least one BFD-RS set, and
at least one candidate beam identity for the at least one BFD-RS set if at least one candidate beam is available for the at least one BFD-RS set.

10. The method of claim 9, wherein the MAC CE comprises a plurality of information segments containing candidate beam availability indication (AC) fields, and each of the plurality of information segments is corresponding to one of the plurality of BFD-RS sets and further contains a first field to indicate whether beam failure is detected for the corresponding BFD-RS set and a second field to indicate a candidate beam identity available for the corresponding BFD-RS set for which the beam failure is detected, and
wherein for each of at least one of the plurality of information segments corresponding to one of the at least one BFD-RS set,
the first field is set to indicate that beam failure is detected for the corresponding BFD-RS set, and the second field is set to indicate a candidate beam identity for the corresponding BFD-RS set if a candidate beam is available for the corresponding BFD-RS set.

11. The method of claim 9, wherein the MAC CE comprises an information segment containing a plurality of beam failure detection (BFD) fields for the cell, and each of the plurality of BFD fields is corresponding to one of the plurality of BFD-RS sets to indicate whether beam failure is detected for the corresponding BFD-RS set, and
wherein each of the plurality of BFD fields corresponding to one of the at least one BFD-RS set is set to indicate that beam failure is detected for the corresponding BFD-RS set.

12. The method of claim 11, wherein the information segment containing the plurality of BFD fields is placed after a cell index bitmap and before at least one information segment containing an AC field in the MAC CE, and
wherein in the case that the cell index bitmap comprises at least two bits set to indicate that beam failure is detected on the cell and the at least one further cell,
the information segment containing the plurality of BFD fields is placed immediately adjacent to at least one further information containing the plurality of BFD fields for the at least one further cell, or
the information segment containing the plurality of BFD fields for the cell is immediately before at least one information segment containing an AC field for the cell in the MAC CE.

13. The method of claim 11, wherein the plurality of BFD fields for the cell are placed adjacent to a plurality of BFD fields for at least one further cell within a BFD bitmap.

14. The method of claim 12 or 13, wherein a size of the information segment containing the plurality of BFD fields for the cell or a size of the BFD bitmap is determined at least based on one of the following:
a total number of BFD-RS sets configured for the cell, or
a configuration received from the network device indicating the size of the information segment containing the plurality of BFD fields for the cell or the size of the BFD bitmap.

15. The method of claim 11, wherein the MAC CE further comprises at least one information segment containing an AC field to indicate at least one candidate beam identity available for a BFD-RS set for which the beam failure is detected.

16. The method of claim 15, wherein each of the at least one information segment containing the AC field further contains a first field to indicate presence of a next information segment containing an AC field, and a second field to indicate a candidate beam identity for the BFD-RS set.

17. The method of claim 9, wherein the MAC CE comprises an information segment containing a BFD field for the cell to indicate the number of BFD-RS sets among the plurality of BFD-RS sets for which beam failure is detected,
wherein in the case that the number of BFD-RS sets is larger than or equal to one, the MAC CE further comprises a number of information segments containing AC fields, the number of the information segments containing the AC fields being equal to the number of BFD-RS sets, and
wherein each of the number of information segments contains a first field to indicate an identity of a corresponding BFD-RS set and a second field to indicate a candidate beam identity for the corresponding BFD-RS set.

18. The method of claim 17, wherein the information segment containing the BFD field for the cell is placed after a cell index bitmap and before at least one information segment containing an AC field in the MAC CE, and
wherein in the case that the cell index bitmap comprises at least two bits set to indicate that beam failure is detected on the cell and the at least one further cell,
the information segment containing the BFD field is placed immediately adjacent to at least one further information containing at least one BFD field for the at least one further cell, or
the information segment containing the BFD field is placed immediately before at least one information segment containing an AC field for the cell in the MAC CE.

19. The method of claim 17, wherein the BFD field for the cell is placed adjacent to at least one BFD field for at least one further cell within a BFD bitmap.

20. The method of claim 19, wherein the size of the BFD bitmap is determined at least based on one of the following:
a total number of BFD-RS sets configured for the cell, or
a configuration received from the network device indicating the size of the BFD bitmap.

21. The method of claim 1, wherein initiating the RA procedure comprises:
determining whether the cell is a special cell; and
in accordance with a determination that the cell is a special cell, initiating the RA procedure.

22. A terminal device, comprising:
a processing unit;
wherein the processing unit is configured to perform the method according to any of claims 1-21.

23. A computer readable medium having instructions stored thereon, the instructions, when executed on at least one processor, causing the at least one processor to perform the method according to any of claims 1-21.
